(19) United States
(12) Patent Application Publication
(10) Pub. No.: US 2009/0262257 A1
(43) Pub. Date: Oct. 22, 2009

(54) BACKGROUND TV

(75) Inventors: TRAVIS CHARLES BAURMANN, San Diego, CA (US); STEVEN FRIEDLANDER, San Diego, CA (US); TRACY HO, San Diego, CA (US); YUKO NISHIKAWA, La Jolla, CA (US); JOHN SALISBURY, Carlsbad, CA (US); MONISH SUBHERWAL, San Diego, CA (US); SABRINA TAI-CHEN YEH, Laguna Beach, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS, INC.

(21) Appl. No.: 12/106,124

(22) Filed: Apr. 18, 2008

(51) Int. Cl. H04N 5/66

(52) U.S. Cl. 348/739; 348/E05.133

(57) ABSTRACT

An ambient, beautiful, entertaining visual experience that can be displayed on a TV requiring little or no user interaction beyond initiation. One theme is a mosaic of panes of; e.g., video from the last-watched channel, with the mosaic covering the screen. Another theme is a clock image with a single moving, fade-in fade-out pane that does not cover the entire screen.

### BACKGROUND TV

I. Field of the Invention

The present invention relates generally to generating an ambient, beautiful, entertaining visual experience that can be displayed on a TV requiring little or no user interaction beyond initiation,

II. Background of the Invention

The increasing capability of TV processing affords heretofore unexplored features that leverage TV operational habits. As recognized herein, one habit that people have developed over the years is leaving their TVs energized in the background even when not being actively watched.

### SUMMARY OF THE INVENTION

A TV system includes a TV display and a processor receiving a user signal to enter a special mode, referred to herein as “background TV”. The special mode entails the presentation of at least one pane on the display that does not fill the display. Content in the pane is derived based on a content source mode of the TV when the user signal is received, with the content in the pane being shuffled automatically without user input.

In a first theme, referred to herein as “storyboard” plural panes arc presented simultaneously on the display, and each pane initially presents visual content derived from a first source of content. At least one pane can be graphically altered to produce a reflection effect.

In non-limiting embodiments, upon starting the special mode, panes displaying respective freeze frames of visual content can pop into existence on the display sequentially until the display is full of panes. If desired, a first freeze frame can be characterized by a first tint of a color and a second freeze frame can be characterized by a second tint of the same color.

A last frame of a sequence of frames to pop in to the display may be made to present moving video as opposed to a freeze frame. The last frame can be larger than other frames and it can display moving video for a period, then freezing the video display and if desired changing to another tint color. During the period the last frame displays moving video, another pane can fade, after which another pane displaying moving video appears, such that a period of overlap in time exists when at least two panes display moving video. After displaying visual content derived from the first source of content in accordance with the first theme, the processor causes the panes to display visual content derived from a second source of content in accordance with the first theme. The sources of content may be TV channels, photo albums, etc.

In a second theme (referred to herein as “clock pop”), the panes are presented such that only a single or a few panes appear at one time on the display without filling the display, along with an image of a clock showing current time. A background portion of the display that does not show panes can change colors over time. The panes can move across the display.

In another aspect, a TV system has a TV display and a processor receiving a user signal to enter a special mode. The special mode presents plural panes simultaneously on the display, with each pane presenting visual content derived from a first source of content. Upon starting the special mode, panes displaying respective freeze frames of visual content pop into existence on the display sequentially until the display is full of panes.

In another aspect, a TV system has a TV display and a processor receiving a user signal to enter a special mode. The special mode presents only a single or a few panes at one time on the display without filling the display, with each pane presenting visual content, along with an image of a clock showing current time.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a non-limiting block diagram of a system in accordance with present principles;

FIG. 2 are non-limiting screen shots showing a user interface that can be used to invoke background TV;

FIG. 3 is a non-limiting screen shot of the “Storyboard” theme;

FIG. 4 is a non-limiting screen shot of the “Clock Pop” theme;

FIG. 5 is a non-limiting table showing how a particular source may be selected for background TV; and

FIG. 6 is a non-limiting flow chart of logic that may be employed by the system of FIG. 1.

### DETAILED DESCRIPTION OF THE PREFERRED EMBODIMENT

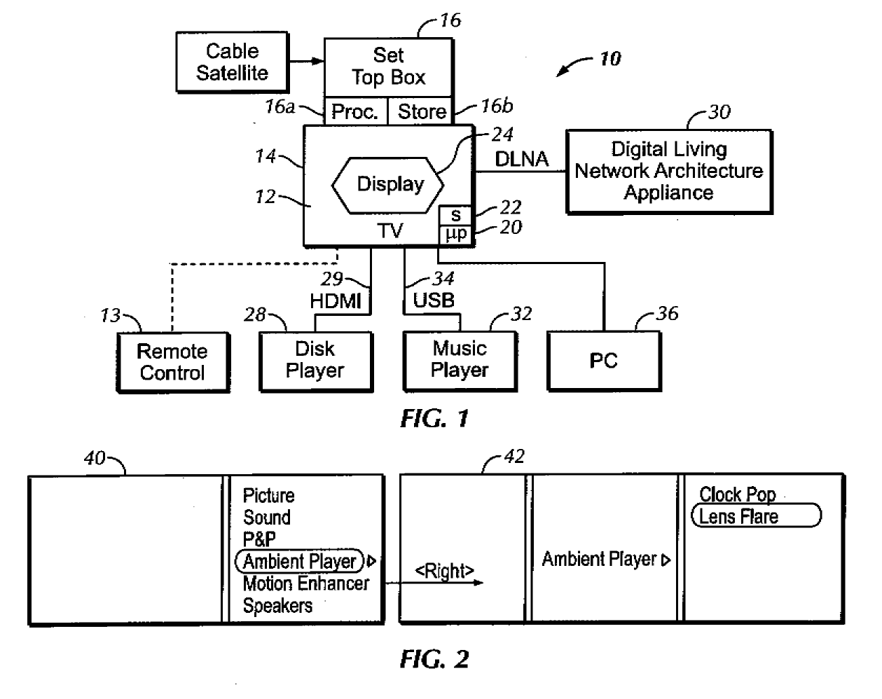

Referring initially to FIG. 1, a system is shown, generally designated 10, which includes a television 12 controllable by a TV remote control 13 and defining a TV chassis 14 and receiving, through a TV tuner in, e.g., a set-top box 16 from a cable or satellite or other source or sources audio video TV programming. The tuner maybe contained in the set box or in the TV chassis 14. When a STB is provided, the STB typically includes a STB processor 16a and STB tangible computer readable medium 16b.

Similarly, the TV 12 typically includes a TV processor 20 accessing a tangible computer readable medium 22. The tangible computer readable medium 22 may be established by, without limitation, solid state storage, optical or hard disk storage, etc. The tangible computer readable media herein may store software executable by one or more of the processors to, e.g., control a display driver that drives a TV visual display 24. The display 24 may be a flat panel matrix display, cathode ray tube, or other appropriate video display. The medium 22 may also contain additional code including 3D graphics software executable by the TV processor 20. One or more of the processors described herein may execute the logic below, which may be stored as computer code on one or more the computer readable media described herein.

In the non-limiting embodiment shown in FIG. 1 the TV 12 may receive programming from external components such as but not limited to a video disk player 28 such as a Blu-Ray or DVD player via a high definition multimedia interface (HDMI) line 29 and a digital living network architecture (DLNA) appliance 30 such as a personal video recorder (PVR) that can contain audio-video streams on a hard disk drive. The TV may also receive audio streams from a music player 32 over a universal serial bus (USB) line 34 as well as multimedia content from a personal computer 36. Additionally, the TV 12 can communicate via a network such as the Internet with content servers.

As used herein, the non-limiting term “background TV” refers to the special mode provided by present principles described further below, and, like the theme names discussed below, is used only for purposes of exposition, not limitation. The term live video texture (LVT) refers to the mapping of live video onto a 3D graphics object within a graphics or video plane.

FIG. 2 shows two screen shots of the display 24 illustrating one non-limiting way to invoke the present background TV. Referring to the left screen shot 40, background TV may be accessed using the remote control 13 by pressing a <Favorites> or <Options> key. This causes the illustrated menu to appear listing “background TV” which can be selected to cause the right screen shot 42 to appear. The right screen shot 42 displays the names of various background TV themes for selection, in this case, “storyboard” and “clock pop”. Both of these themes are described further below.

Background TV may be accessible at any time when the TV 12 is in any one of the following input modes: RF, composite, component, HDMI, digital media port (DMPort), or PC. Background TV may also be accessible whenever the user selects USB or DLNA mode. Background TV may also be accessed from a “favorites” menu.

When accessing background TV from a “favorites” menu, within the content carousel, each background TV theme can be associated with a canned animated icon (a mini preview of what the theme is). Background TV can be accessed from the present assignees cross-menu bar (XMB); when XMB is not available, an “options” menu can be used to access background TV. If a slideshow or a music visualizer is accessible from the options menu, background TV can be accessible.

When XMB is implemented, background TV may not be accessible from the first layer of the XMB but instead may be accessible on the second and third layers of XMB (files or folders). Examples of user actions to invoke background TV include: from XMB >Music>USB, in which ease the options menu may not list background TV. Or, from XMB>Music>USB>User's Folder, in which case the options menu may list background TV. As yet another example, from XMB>External Inputs>HDMI, in which case the options menu may list background TV.

When background TV is invoked, an options menu can be presented to allow a user to add or remove background TV from a “favorites” menu. Typically, whenever background TV is accessed, the theme last launched (either through favorites or options) will assume the default focus in the options sub-menu.

In non-RF modes (i.e., when background TV is accessed when the TV is not in a mode in which TV programming is being received from, e.g., the STB but in another mode), the following non-limiting logic can be implemented. Accessing background TV can occur when in the external video input mode, including PC input mode. In contrast, when in modes such as a XMB photo or music viewer mode, selecting background TV will exit the TV from the current mode and display background TV themes using content from that mode.

To exit background TV and return to the previous mode, an appropriate key on the RC 13 may be manipulated. For example, if the user presses <RETURN>, background TV is exited and the current input, channel, or application displayed.

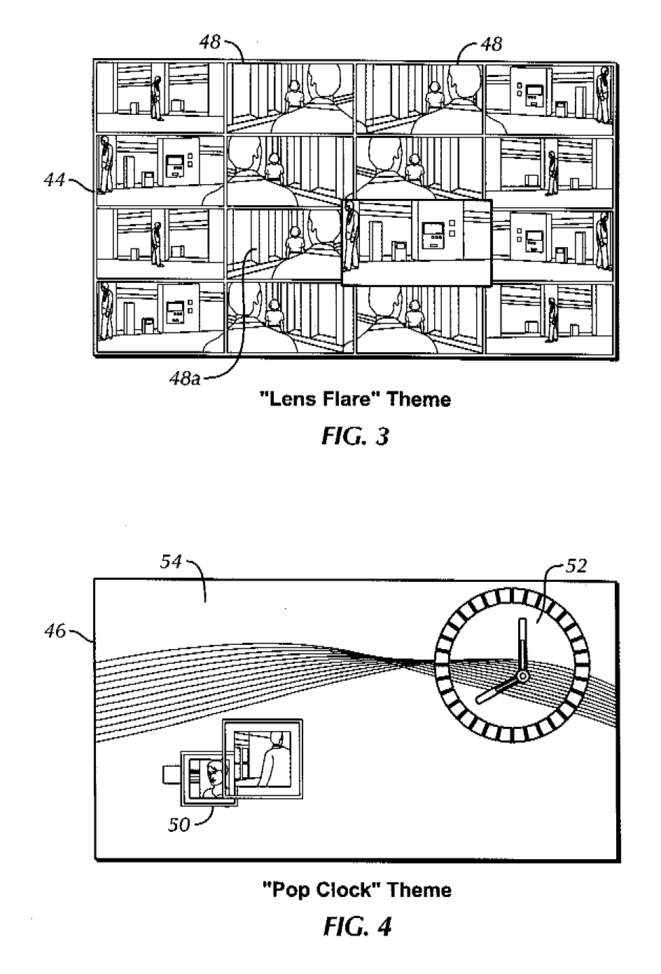

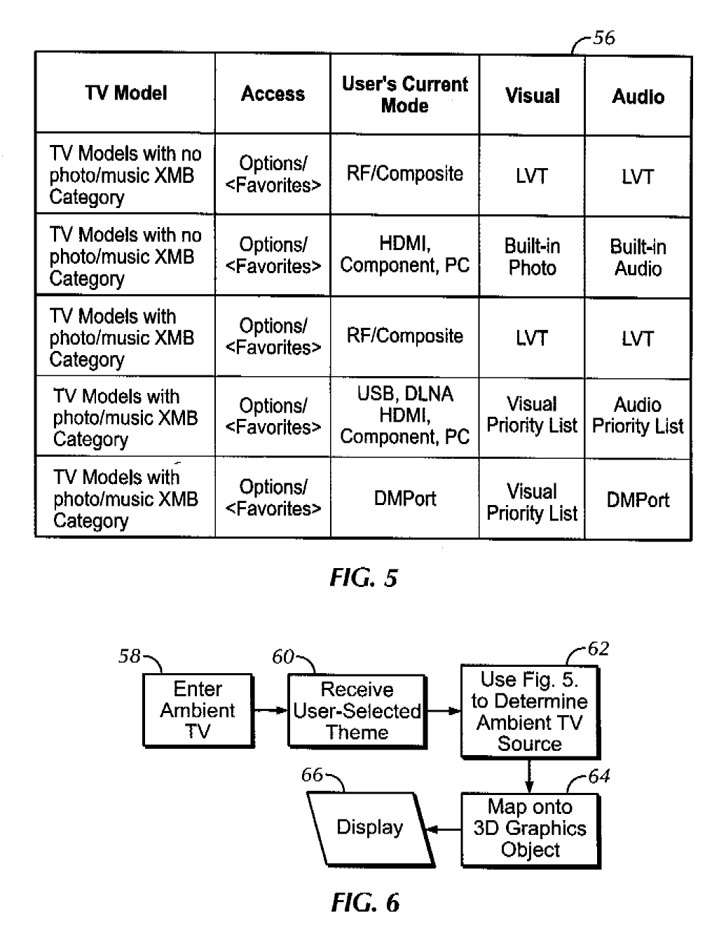

As mentioned above, multiple background TV themes may be provided, with each theme preferably using content that depends on the mode of the TV when background TV is accessed in accordance with, e.g., the non-limiting example of FIG. 5 discussed below. FIG. 3 shows a screen shot 44 of one such theme that may be presented on the display 24, while FIG. 4 shows a screen shot 46 of a second such theme.

In essence, the theme shown in FIG. 3, labeled “storyboard” only for disclosure purposes, is a mosaic of image panes 48 that, when LVT is used as the theme content, are all derived from the same video feed. When the TV is in a photo application mode when background TV is accessed, the content of the panes 48 is derived from, e.g., the last-viewed photo, and similarly for a music visualization application. Present principles may be extended to deriving background TV pane 48 content from the content of other TV modes that may be played by the TV at the time that background TV is invoked.

In the non-limiting embodiment shown, plural panes 48, which may be established by visual placeholders on a graphics plane, may be provided. One pane 48a may be graphically altered to produce a reflection effect as shown (note the subject looking to the left in pane 48a and to the right in the other panes). This reflection pane 48a can be capable of being live and can be animated when LVT is playing.

Upon starting background TV in the theme shown in FIG. 3, freeze frames of LVT can be made to pop into existence sequentially in random screen locations until the screen is fill of panes 48. The freeze frames can be different tints of one color. The last pane to pop in is then replaced by the LVT, and it can be made to grow a bit larger than other panes, e.g., 110% of the size of other panes 48. The larger pane can display LVT for a short period and then freeze, change to another tint color, and shrink to normal pane 48 size. During the period the last frame in larger format is animating, another pane 48 (displaying a freeze frame) can begin to fade out, after which another LVT will begin at the same location. Thus, there can be a brief period of overlap in time when two panes 48 are animating.

If desired, after the first time LVT freeze frame panes 48 populate and fill the screen, all LVT freezing afterward can leave freeze frames of different colors. Also, an evaporation effect can be provided in which periodically an animation effect occurs with the current LVT finishing its animation. Then, all freeze frame panes pop out of existence similar to the effect used to populate panes in the beginning. The panes 48 then pop back into existence and the algorithm described above repeat.

When the evaporation effect is applied, LVT will begin again. This lime, the pane 48 LVT content can be derived from a different source than the last-tuned to channel, e.g., from the first channel in a “favorite channel” list. If no favorite channels are listed, the first channel in a channel history list may be used. If there is nothing in history besides the current channel, then LVT from channels in the entire channel map starting from the lowest available channel for current tuning mode, antenna or cable) can begin playing after evaporation occurs.

When photo content is used for pane 48 content, the same process can be followed except that pictures can appear for approximately five seconds. If the user has less than sufficient photos to fill all respective panes on the screen, the entire screen can be filled with as many of photos that can fit.

In any cases the panes all display content from the same first source, evolve in appearance in the non-limiting way described through a cycle, and then repeat another cycle but with content commonly derived from a second source.

Turning to FIG. 4 for a description of a second background TV theme, as shown the display 24 is never filled with panes 50 but rather only a single or a few panes 50 appear at one time, along with an image 52 of a clock showing current time. The theme of FIG. 4 may be presented without the geometric fractal shown in the background.

The background 54 (i.e portion of the display 24 that does not show images in panes 50) of the theme in FIG. 4 preferably changes colors. The panes 50 can float across the screen from, e.g., left to right, and then loop back and forth.

The content rules for the panes 50 are the same as those for the panes 48 in FIG. 3 and as more fully discussed below. If LVT is being used as the content for the panes, when a pane 50 reaches the edge of the screen, the LVT used for the content can be changed to be that from the first channel in a favorites list, then from history, and so on as described above for the theme shown in FIG. 3. The LVT in a pane 50 may play for a short period, then freeze, fade a bit without disappearing, then shrink in a real size. When photos are used as the content for the panes 50, the same rules can be followed. For both LVT and photo content, the faded and shrunk panes 50 can disappear once the panes reach the left or right edge of the screen.

FIG. 5 shows a non-limiting table 56 that correlates TV model capabilities in the left column with background TV access locations in the second column, current TV mode in the third column, and source of initial visual and audio content for the background TV display in the fourth and fifth columns.

As indicated in FIG. 5, a background TV theme can use video and audio from either LVT, a user's device, or content built in to the background TV itself, For all themes presented, if the user's selected input or mode allows LVT, then LVT preferably is used for video and audio.

Themes that use photo or audio content can shuffle (randomly select) through content as described above. Themes can function on TV models with or without photo/music XMS categories. Shuffling through content from another device (USB or DLNA), however, may not be allowed, whereas shuffling through folders or embedded folders (folders within folders) can be allowed.

FIG. 5 illustrates non-limiting dynamics between device content, the user's TV model, and the user's current mode. For example, LVT from the currently tuned-to channel (RF/composite mode) in TV models without photo/music capability (top row) initially (i.e., at background TV invocation) is used as a source for the initial content in the panes of either theme shown in FIG. 3 or 4, with shuffling through LVT content sources then proceeding subsequently as described above. In the second row, for such TVs in a HDMI mode, or component mode, or PC mode, photos and audios that are built in to the background TV are used when background TV is invoked. Likewise, LVT is used (third row) in the REF/composite mode for TVs that have photo/music capability.

The fourth row illustrates that XMB photo/music-capable TVs in the USB or DLNA or HDMI or component or PC mode access the non-limiting priority lists set forth below in establishing video and audio content of the panes of the selected background TV theme, starting with the first cycle. Thus, in the first cycle when the TV is in the photo view mode, the last photo selected provides the initial content for the panes, with succeeding photos providing the content for subsequent cycles. As indicated by the fifth row, the below-described visual priority list is used for theme content for such TVs in the DMPort mode, while DMPort audio is used for the audio content of the background TV theme.

The following specifics which device type may be accessed for photo content for the background TV. It is preferable to always use the content from the current mode selected as top priority: top priority, USB, next priority, DLNA, next priority, built-in photos on, e.g., flash memory of the TV 12.

For example, if the user enters DLNA mode that has ONLY photos, then he/she selects background TV, the processor executing background TV will check the audio priority list, which in one non-limiting embodiment maybe established by the following. Note that it is preferred to always use the content from the current mode selected as top priority. Top priority, USB; next, built-in audio on flash memory of the TV. DMPort can only be accessed when TV's input is in DMPort so it is not on the priority list. For example, if the user enters DLNA mode with photos, then he/she selects background TV, background TV will cheek the audio priority list.

FIG. 6 illustrates the principles above in flow chart format. At block 58 the processor receives a user signal from the RC 13 to enter background TV, and at block 60 the user's selection of the particular theme is received. The content for the panes of the theme is then derived at block 62 from the sources described above and as illustrated in one non-limiting embodiment by the table of FIG. 5. In some embodiments the panes can be mapped onto a 3D graphics plane at block 64 and displayed as described at state 66.

In non-limiting implementations, the following error processing may be used. Error messages maybe displayed in the lower right corner of the display over the ambient theme. Because present principles are to encourage a passive experience, reverting to built-in photos or audio is preferred in the presence of an error rather than exiting background TV. Furthermore, messages such as clip messages or dialogs are not necessarily desired. Instead, preferably an alteration between trying to fetch content and checking for other devices or content is used. This is defined as the fetching algorithm. In one embodiment, the fetching algorithm is that, if photo or audio content is not available, built-in photo Or audio is immediately displayed in background TV. During the time for the theme to process that built-in photo or audio, the user's next photo or audio is fetched to see if it is valid. If fetching is successful, the user's photo or audio is used for the theme. If fetching is not successful, built-in photo or audio is displayed. Repeat this algorithm infinitely. If the user has one photo, keep retrieving that one photo.

Errors related to LVT include the absence of a signal from the RF input or any other Input, in which case a blank black screen may be displayed with a clip message stating that there is no signal or no input (i.e., signal cannot be decoded). The clip message may be displayed on top of the current ambient theme. If a program or channel to be used as LVT in the background TV is blocked, a blank black screen can be displayed with a lock icon indicating that the program or channel is blocked.

If the system clock is not set (either due to TV power restart or user not setting the time), a system default time is used and animated to mimic clock operation. If aberrations to video playback (forward, rewind, pause, etc.) exist when background TV is started, the aberrated video (in slow motion or fast speed or reverse, for instance) may be displayed as video. Or, when video is being aberrated the system may treat the event as a “no signal” event as described above.

While the particular background TV is herein shown and described in detail, it is to be understood that the subject matter which is encompassed by the present invention is limited only by the claims.

What is claimed is:

1. A TV system, comprising:
a TV display; and
a processor receiving a user signal to enter a special mode, the special mode entailing the presentation of at least one pane on the display, the pane not filling the display, content in the pane being derived at least in part based on a content source mode of the TV when the user signal is received, content in the pane being shuffled automatically without user input.

2. The system of claim 1, wherein plural panes are presented simultaneously on the display in a first theme, each pane presenting visual content derived from a first source of content.

3. The system of claim 2, wherein at least one pane is graphically altered to produce a reflection effect.

4. The system of claim 2, wherein upon starting the special mode, panes displaying respective freeze frames of visual content pop into existence on the display sequentially until the display is full of panes.

5. The system of claim 4, wherein a first freeze frame is characterized by a first tint of a color and a second freeze frame is characterized by a second tint of the color.

6. The system of claim 4, wherein a last frame of a sequence of frames to pop in to the display presents video.

7. The system of claim 6, wherein the last frame is larger than other frames.

8. The system of claim 7, wherein the last frame displays moving video for a period and then freezes the video display, changing to another tint color.

9. The system of claim 8, wherein during the period the last frame displays moving video, another pane fades, after which another pane displaying moving video appears, such that a period of overlap in time exists when at least two panes display moving video.

10. The system of claim 2, wherein after displaying visual content derived from the first source of content in accordance with the first theme, the processor causes the panes to display visual content derived from a second source of content in accordance with the first theme.

11. The system of claim 1, wherein the panes are presented in accordance with a second theme in which only a single or a few panes appear at one time on the display without filling the display, along with an image of a clock showing current time.

12. The system of claim 11, wherein a portion of the display that does not show panes changes colors over time.

13. The system of claim 12, wherein at least one pane moves across the display.

14. A TV system, comprising:
a TV display; and
a processor receiving a user signal to enter a special mode, the special mode presenting plural panes simultaneously on the display, each pane presenting visual content derived from a first source of content, wherein upon starting the special mode, panes displaying respective freeze frames of visual content pop into existence on the display sequentially until the display is full of panes.

15. The system of claim 14, wherein at least one pane is graphically altered to produce a reflection effect.

16. The system of claim 14, wherein a first freeze frame is characterized by a first tint of a color and a second freeze frame is characterized by a second tint of the color.

17. The system of claim 14, wherein a last frame of a sequence of frames to pop in to the display presents video.

18. The system of claim 14, wherein after displaying visual content derived from the first source of content in accordance with a first theme, the processor causes the panes to display visual content derived from a second source of content in accordance with the first theme.

19. A TV system, comprising:
a TV display; and
a processor receiving a user signal to enter a special mode, the special mode presenting only a single or a few panes at one time on the display without filling the display, each pane presenting visual content, along with an image of a clock showing current time.

20. The system of claim 19, wherein at least one pane moves across the display.

21. The system of claim 19, wherein after displaying visual content derived from the first source of content, the processor causes the panes to display visual content derived from a second source of content.
